(19) United States
(12) Patent Application Publication
(10) Pub. No.: US 2006/0161689 A1
(43) Pub. Date: Jul. 20, 2006

(54) Apparatus and systems for monitoring communication

(75) Inventor: Stephen Frederick Anderson, Flowermound, TX (US)

Correspondence Address: SCHWEGMAN, LUNDBERG, WOESSNER & KLUTH, P.A., P.O. BOX 2938, MINNEAPOLIS, MN, 55402, US

(73) Assignee: Hewlett-Packard Development Company, L.P.

(21) Appl. No.: 11/038,511

(22) Filed: Jan. 18, 2005

(51) Int. Cl. G06F 3/00

(52) U.S. Cl. 710/5

(57) ABSTRACT

Apparatus and systems may include a connector to connect lines sending or receiving data between two communicating devices to lines communicating the data to a monitoring computer system. The monitoring computer system may display the data sent between the two devices.

### BACKGROUND INFORMATION

Computer systems and peripherals often transmit and receive data using communications interfaces. For example, computer systems may communicate with one another or with peripherals using a serial communications interface that conforms to the RS-232C protocol.

It is sometimes useful to troubleshoot problems with the communication of data between two computing systems or a computing system and its peripherals. In these situations, a special purpose datascope is typically used. A datascope is a device that monitors the data and signaling protocols involved in communications between computing devices and peripherals and displays the data and signals to a user.

While datascopes are useful tools in diagnosing communications problems, they are relatively expensive, typically costing several thousands of dollars. As a result, datascopes are not a realistic solution for many computer users.

### BRIEF DESCRIPTION OF THE DRAWINGS

FIG. 1 is a block diagram of an operating environment in which embodiments of the invention may be practiced;

FIG. 2 is a block diagram illustrating communication signal lines according to embodiments of the invention;

FIG. 3 is a block diagram illustrating a cable assembly according to embodiments of the invention;

FIG. 4 is a block diagram illustrating a cable assembly according to alternative embodiments of the invention;

FIG. 5 is a block diagram illustrating a monitor cable mating apparatus according to embodiments of the invention;

FIG. 6 is a block diagram of a software system according to embodiments of the invention;

FIG. 7 is a flowchart of a method according to embodiments of the invention; and

FIG. 8 is a diagram of an example screen displayed by embodiments of the invention.

### DETAILED DESCRIPTION

Example embodiments of apparatus and systems may include a connector to connect lines communicating data between two computer devices to lines communicating the data to a monitoring computer system. The monitoring computer system may display the data sent between the two devices.

In the following detailed description of example embodiments of the invention, reference is made to the accompanying drawings that form a part hereof, and in which is shown by way of illustration, and not of limitation, specific example embodiments in which the subject matter may be practiced. These embodiments are described in sufficient detail to enable those skilled in the art to practice the various embodiments of the invention, and it is to be understood that other embodiments may be utilized or derived from this disclosure such that logical, mechanical, electrical and other changes may be made without departing from the scope this disclosure. This detailed description, therefore, is not to be taken in a limiting sense.

In the figures, the same reference number is used throughout to refer to a substantially similar component which appears in multiple figures. Signals and connections may be referred to by the same reference number or label, and the actual meaning will be clear from its use in the context of the description.

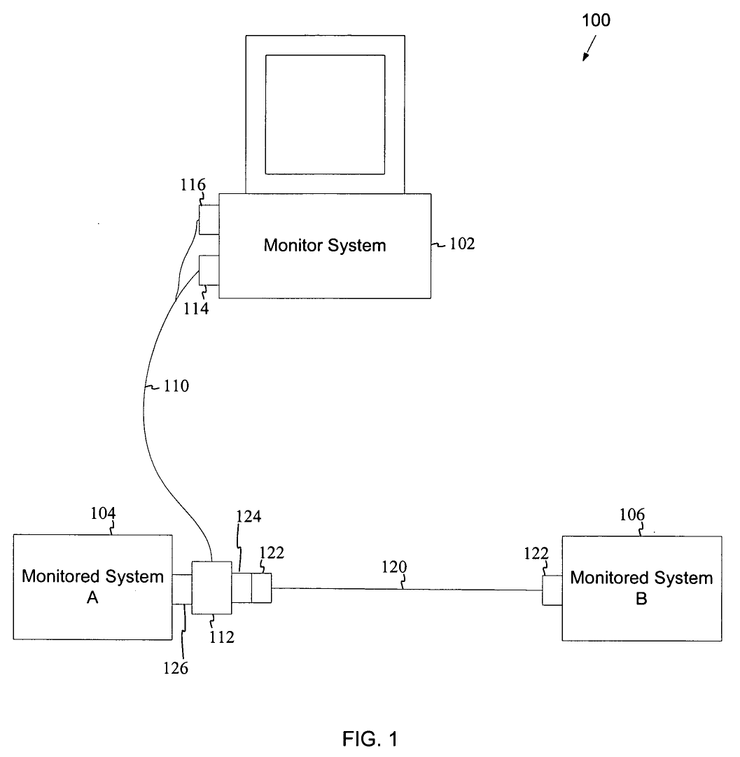

FIG. 1 is a block diagram of an operating environment 100 in which embodiments of the invention may be practiced. In general, the operating environment includes a monitoring computer system 102 and two monitored communicating devices 104 and 106 that communicate via a communications line 120. Monitored systems 104 and 106 may comprise two computers that communicate with one another, a computer and a device that communicate with one another, or two devices that communicate with one another.

Communications line 120 comprises a cable with connectors 122 at either end configured to connect the cable to a suitably configured port on a communicating device. In some embodiments, communications line 120 may be a serial communications cable that conforms to the RS-232 (Recommended Standard) serial communications protocol approved by the Electronics Industry Alliance (EIA). Connectors 122 may be DB-9 type connectors or DB-25 type connectors.

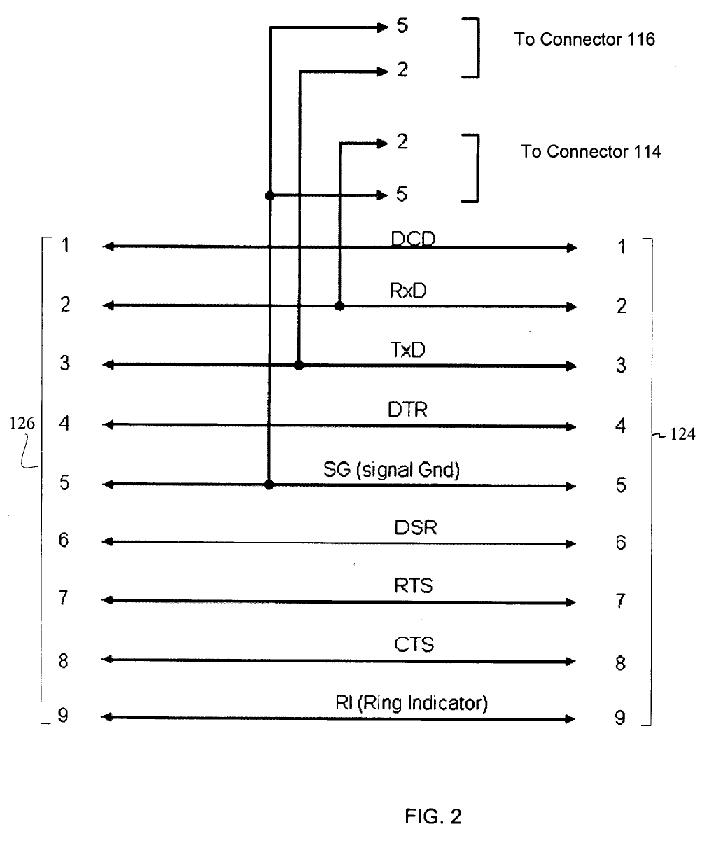

In some embodiments, a monitor cable 110 includes two connectors 114 and 116 at one end of the cable, and a monitor connector housing 112 at the other end of cable 110. The two connectors 114 and 116 may couple with the monitor system 102. Monitor connector housing 112 includes two connectors 124 and 126 that may couple with the two monitored communicating devices 106 and 104, respectively. The communications line 120 may couple the device 106 and the monitor connector housing 112. Each of the connectors 114, 116, 124 and 126 may be DB-9 or DB-25 style connectors. In addition, monitor connector housing 112 may contain circuitry and/or lines communicably coupling lines from communications line 120 to lines in cable 110. Further details on this connection are provided below with reference to FIG. 2.

In operation, connector 126 of monitor connector housing 112 is connected to a communications port on monitored system 104 and connector 124 of monitor connector housing 112 is connected to a first connector 122 of communications line 120. The second connector 122 of communications line 120 is connected to the other monitored system 126. Connectors 114 and 116 are connected to communications ports on monitoring system 102. In some embodiments, communications ports on monitoring system 102 are serial communications ports. Data sent and received by monitored systems 104 and 106 may be communicated to monitoring system 102 via cable 110.

FIG. 2 is a block diagram illustrating communication signal lines in monitor connector housing 112 according to embodiments of the invention. In the example shown in FIG. 2 is a 9 line RS-232C standard communication protocol. Various types of signals are sent and received over the lines in RS-232C type communications. In the example shown in FIG. 2, these lines include DCD (Data Carrier Detect), RxD (Receive Data), TxD (Transmit Data), DTR (Data Terminal Ready), SG (signal ground), DSR (Data Set Ready), RTS (Ready To Send), CTS (Clear To Send) and RI (Ring Indicator). In some embodiments, the RxD line between connectors 124 and 126 is coupled to the RxD line running to connector 114. For clarity, the RxD line between connectors 124 and 126 may be referred to as a monitored RxD line. In addition, the TxD line between connectors 124 and 126 is coupled to the RxD line running to connector 116. Again, for clarity, the TxD line running between connectors 124 and 126 may be referred to as a monitored TxD line. Further, the SG line running to connectors 114 and 116 is tied to the SG line between connectors 124 and 126. Thus, the transmit data and receive data from a monitored communications line 120 may be also routed to two receive data lines coupled to a monitoring computer system 102. In some embodiments, wires running between connectors 124 and 126 in monitor connector housing 112 are tied to wires running to connectors 114 and 116. In alternative embodiments, a printed circuit board in monitor connector housing 112 is used instead of, or in addition to wires, and the connections are made on the printed circuit board.

Alternative embodiments may use other types of communications protocols and are within the scope of the present invention. For example, EIA-232-D, EIA/TIA-232-E, RS-422 and RS-423 signaling and line protocols may be employed in alternative embodiments of the invention.

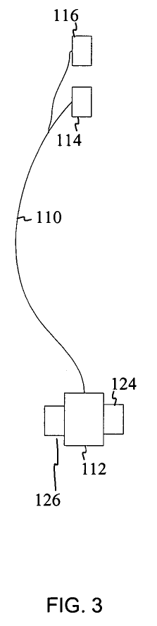

FIG. 3 is a block diagram illustrating a cable assembly according to embodiments of the invention. In these embodiments, the cable assembly includes cable 110, connectors 114 and 116, and monitor connector housing 112 with connectors 124 and 126. This embodiment is connected and operates as described above with reference to FIGS. 1 and 2.

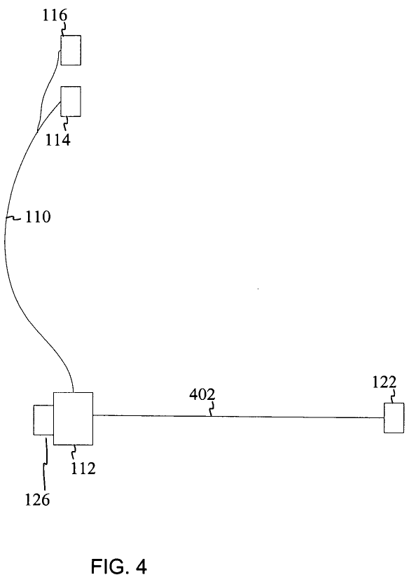

FIG. 4 is a block diagram illustrating a cable assembly according to alternative embodiments of the invention. In these embodiments, connector 124 and the adjacent connector 122 (shown in FIG. 1) are replaced by second cable 402. Lines running through cable 402 are connected at one end of second cable 402 as described above in FIG. 2 with respect to monitor connector housing 112. The lines extend to second end of cable 402, which has a connector 122 for coupling the cable assembly to the second monitored communicating device 104. The device 104 may be coupled directly to the connector 122 of FIG.4 without an additional cable (e.g. without cable 120).

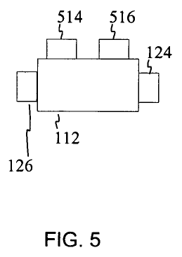

FIG. 5 is a block diagram illustrating a monitor cable mating apparatus according to alternative embodiments of the invention. In these embodiments, cable 110 is not present, and is replaced by two connectors 514 and 516. Connectors 514 and 516 each have communications lines in monitor connector housing 112 coupled to the lines running between connectors 124 and 126 as described above with respect to FIG. 2. In these embodiments, the user may supply cables to connect the monitor connector housing 112 to two communications ports on monitoring system 102 via connectors 514 and 516.

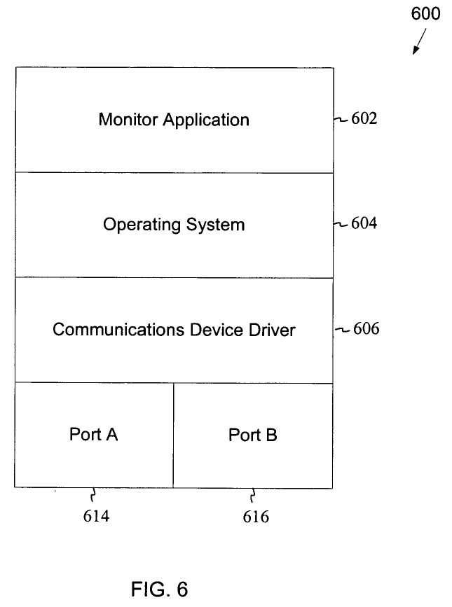

FIG. 6 is a block diagram of a software system 600 according to embodiments of the invention. In some embodiments, software system 600 includes a datascope application 602, an operating system 604, and a communications device driver 606 that provides an interface between communications ports 614 and 616 (which are similar to ports 114 and 116). In some embodiments, communications ports 614 and 616 are serial communications ports conforming to the RS-232C communications protocol. In these embodiments, the communications ports may be configured as 9 pin or 25 pin ports.

Communications device driver 606 provides an interface between the hardware ports and the operating system and software running on monitoring system 102. As is known in the art, device driver 606 makes use of the particular commands and physical interfaces provided by a particular communications device used to transmit and receive data on a serial communications line. In addition to being hardware dependent, device drivers are typically also operating system dependent.

Operating system 604 controls the execution of applications on monitoring system 102, and further provides interfaces to various system resources such as communications ports 614 and 616 through device driver 606. Examples of operating systems include Windows® 95, Windows 98®, Windows Me®, Windows CE®, Windows® NT, Windows 2000®, and Windows XP® by Microsoft Corporation. However, no embodiment of the present invention is limited to any particular operating system, and in alternative embodiments the software components may operate on variants of the UNIX and Linux operating systems and any other operating system supporting multiple communications ports.

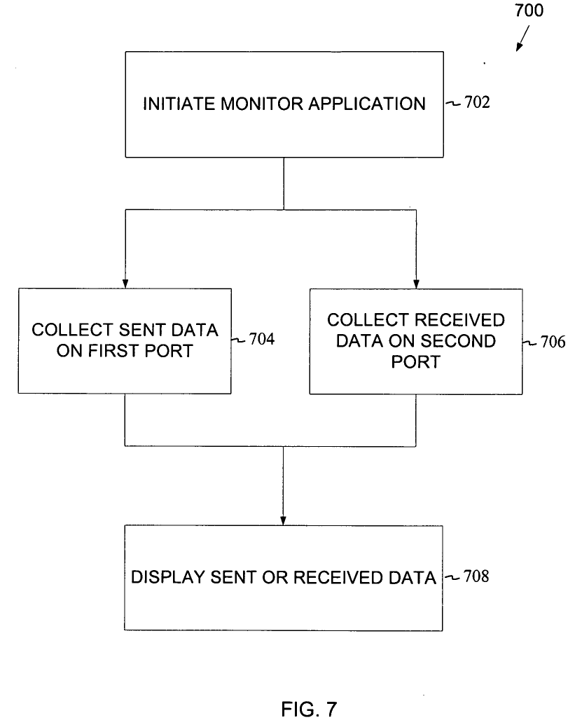

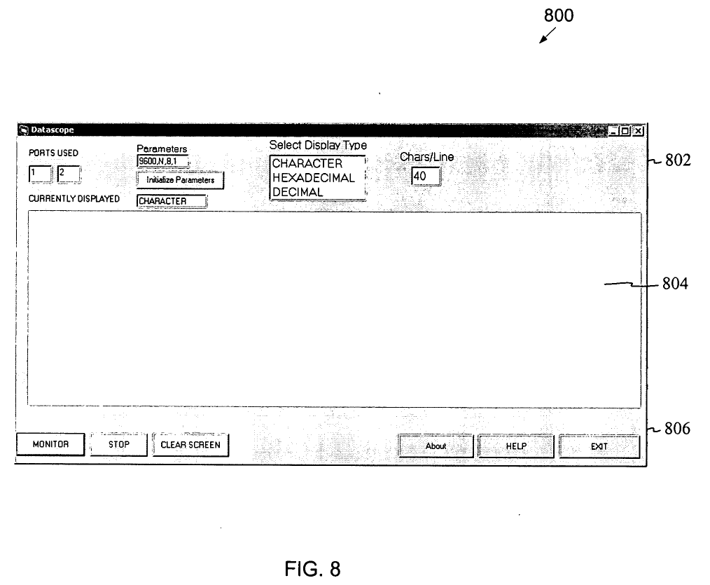

Monitor application 602 runs on monitor system 102 under the control of operating system 604, and uses the facilities provided by operating system 604 to configure ports 614 and 616 and to receive data from ports 614 and 616. As discussed above, the data received on ports 614 and 616 may comprise the signals sent and received between two monitored systems 104 and 106. In some embodiments, the data received on ports 614 and 616 is displayed via a user interface screen of application 602. A sample user interface screen is described below with reference to FIG. 8. Further details on the operation of monitor application 602 are provided below with reference to FIG. 7.

FIG. 7 is a flowchart of a method according to embodiments of the invention. The method may be performed within an operating environment such as that described above with reference to FIGS. 1 and 6. The methods to be performed by the operating environment constitute computer programs made up of computer-executable instructions. Describing the methods by reference to a flowchart enables one skilled in the art to develop such programs including such instructions to carry out the methods on suitable computers (the processor of the computer executing the instructions from machine-readable media such as RAM, ROM, CD-ROM, DVD-ROM, flash memory etc.). The methods illustrated in FIG. 7 are inclusive of the acts performed by an operating environment executing an example embodiment of the invention.

The method begins by initiating a monitor application (block 702). As part of the initialization process, various configuration parameters may set or read from configuration data. In some embodiments, the configuration parameters include port identification of ports on the monitoring system that are to be used to receive monitored data, the baud rate for the communications, parity information, number of bits used for data (typically 7 or 8) and the number of stop bits. In some embodiments, data received from the monitored systems may be displayed in a number of different formats, including character, hexadecimal, or decimal. Additional configuration information includes setting the number of characters per line that may be displayed.

Next, the system proceeds to receive data on the two ports configured as monitor ports. It should be noted that data may arrive on the ports in any order, thus both ports may be monitored simultaneously. The method thus collects received data on one port (block 704), and collects sent data on a second port (block 706). For convenience, the concept of sent and received data is established from the point of view of one of the monitored systems. Thus sent data on one system may be substantially the same as received data on the second system and vice versa.

Finally, the system displays the data collected at blocks 704 and 706 (block 708). A user interface for such display is illustrated below with reference to FIG. 8. In alternative embodiments, the sent and received data may be logged to a file instead of, or in addition to, being displayed.

It should be noted that the methods described herein do not have to be executed in the order described, or in any particular order. The words “subsequent,” “prior,” and similar terms are used to make it clear that a particular activity may come after, or precede, another, respectively. Moreover, various activities described with respect to the methods identified herein can be executed in simultaneous, serial, or parallel fashion. For the purposes of this document, the terms “information” and “data” may be used interchangeably. Information, including parameters, commands, operands, instructions, and other data, can be sent and received in the form of one or more carrier waves.

FIG. 8 is a diagram of an example screen 800 displayed by embodiments of the invention. In some embodiments, screen 800 includes a configuration area 802, a display area 804, and a control area 806. Configuration area 802 provides a mechanism to receive and display configuration parameters. In those embodiments where the RS-232C protocol is used, this configuration data may include port identification of ports on the monitoring system that are to be used to receive monitored data, the baud rate for the communications, parity information, number of bits used for data and the number of stop bits.

Display area 804 is used in some embodiments to display the data received as a result of monitoring the communication line between two monitored systems. In some embodiments, the sent and received data is displayed on alternating lines, with sent data on one line and received data on an adjacent line. The sent data and received data may be highlighted in any one of a number of manners. For example, in some embodiments, the sent data and received data lines have differing backgrounds. In alternative embodiments, bolding, underlining, italicization or other highlighting mechanism may be used. In further alternative embodiments, the display area may be divided into two sections top to bottom or left to right, with one section displaying sent data and the other section display received data.

Control area 806 in some embodiments provides user interface elements to control the operation of the monitor application. In some embodiments, the user interface elements comprise buttons to start and stop data monitoring, a button to clear display area 804 of previously displayed data, a button to exit the monitor application, and a button to provide help and other information regarding the monitor application.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using any of a number of mechanisms well-known to those skilled in the art, such as application program interfaces or inter-process communication techniques, including semaphores and remote procedure calls. The teachings of various embodiments are not limited to any particular programming language or environment.

Although specific embodiments of the invention have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b) to allow the reader to quickly ascertain the nature of the technical disclosure. It is submitted with the understanding that it will not be used to interpret or limit the scope or meaning of the claims. In addition, in the foregoing detailed description, it can be seen that various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the detailed description, with each claim standing on its own as a separate embodiment.

What is claimed is:

1. A method, comprising:
receiving on a first communications port of a computer data sent by a first device to a second device;
receiving on a second communications port of the computer data sent by the second device to the first device; and
displaying by the computer the data sent by the first device and the data sent by the second device.

2. The method of claim 1, wherein the data sent by the first device and the data sent by the second device conforms to a serial communications protocol.

3. The method of claim 2, wherein the communications protocol comprises the RS-232 communications protocol.

4. The method of claim 1, wherein displaying the data includes highlighting the data sent by the first device to the second device.

5. The method of claim 1, further comprising selecting the first communications port and the second communications port from a plurality of communications ports on the computer.

6. The method of claim 1, further comprising configuring the first communications port and the second communications port to conform to communications parameters of the data sent by the first device.

7. An apparatus, comprising:
a housing;
means for connecting a receive data line of a first plurality of lines in the housing to a first receive data line of a second plurality of lines;
means for connecting a transmit data line in the first plurality of lines to a second receive data line in the second plurality of lines;
means for coupling the first receive data line to a first communications port on a computer; and
means for coupling the second receive data line to a second communications port on a computer.

8. The apparatus of claim 7, wherein the means for connecting the receive data line and the means for connecting the transmit data line comprise wire lines.

9. The apparatus of claim 7, wherein the means for connecting the receive data line and the means for connecting the transmit data line comprise lines on a printed circuit board.

10. A computer-readable medium having computer executable instructions for performing a method, the method comprising:
receiving on a first communications port of a computer data sent by a first device to a second device;
receiving on a second communications port of the computer data sent by the second device to the first device; and
displaying by the computer the data sent by the first device and the data sent by the second device.

11. The computer-readable medium of claim 10, wherein the data sent by the first device and the data sent by the second device substantially conforms to a serial communications protocol.

12. The computer-readable medium of claim 11, wherein the communications protocol comprises the RS-232 communications protocol.

13. The computer-readable medium of claim 12, wherein displaying the data includes highlighting the data sent by the first device to the second device.

14. The computer-readable medium of claim 10, wherein the method further comprises selecting the first communications port and the second communications port from a plurality of communications ports on the computer.

15. The computer-readable medium of claim 10, wherein the method further comprises configuring the first communications port and the second communications port to conform to communications parameters of the data sent by the first device.

16. A cable comprising:
a plurality of lines extending from a first end to a second end, said lines including a first receive data line and a second receive data line;
a monitor transmit connector and a monitor receive connector coupled to the first end, the monitor transmit connector including the first receive data line and the monitor receive connector including the second receive data line;
a housing coupled to the second end, the housing including at least a first connector; and
a second plurality of lines coupled to the first connector, including a transmit data line connected to the first receive data line and a receive data line connected to the second receive data line.

17. The cable of claim 16, further comprising a second connector in the housing, wherein the plurality of lines are connected to the second connector.

18. The cable of claim 16, further comprising a second cable, wherein the second plurality of lines extend through the second cable.

19. The cable of claim 16, further comprising a second connector and wherein the second plurality of lines are coupled to the second connector.

20. The cable of claim 19, wherein the second plurality of lines include lines on a printed circuit board residing in the housing.

21. The cable of claim 19, wherein the second plurality of lines comprise wire lines.

22. An apparatus, comprising:
a housing, said housing including a first connector and a second connector, a plurality of lines including a transmit data line and a receive data line extending between the first connector and the second connector;
a monitor transmit connector included in the housing, said monitor transmit connector including a first receive data line connected to the transmit data line; and
a monitor receive connector included in the housing, said monitor receive connector including a second receive data line connected to the receive data line.

23. The apparatus of claim 22, wherein the plurality of lines include lines on a printed circuit board residing in the housing.

24. The apparatus of claim 22, wherein the plurality of lines comprise wire lines.

25. A system comprising:
a first communications port on a computer and a second communications port on the computer; and
a monitor application to:
receive data from the first communications port and the second communications port, and
display the data received on the first communications port and the second communications port.

26. The system of claim 25, wherein the first communications port and the second communications port receive data that substantially conforms to a serial communications protocol.

27. The system of claim 26, wherein the communications protocol comprises the RS-232 communications protocol.

28. The system of claim 25, wherein displaying the data includes highlighting the data received on the first communications port.

29. The system of claim 25, further comprising selecting the first communications port and the second communications port.

30. The system of claim 25, further comprising configuring the first communications port and the second communications port to conform to the communications parameters of the data sent by the first communicating device.
